(19) United States
(12) Patent Application Publication
(10) Pub. No.: US 2010/0282031 A1
(43) Pub. Date: Nov. 11, 2010

(54) SOCKET FOR SOCKET WRENCH AND METHOD FOR FIXING MEMBER TO BE FASTENED

(75) Inventors: Noriyuki Takeda, Tokyo (JP); Shoichi Doi, Hyogo (JP)

Correspondence Address: LOWE HAUPTMAN HAM & BERNER, LLP, 1700 DIAGONAL ROAD, SUITE 300, ALEXANDRIA, VA, 22314, US

(73) Assignee: MITSUBISIHI HEAVY INDUSTRIES, LTD, Tokyo (JP)

(21) Appl. No.: 12/811,111

(22) PCT Filed: Jan. 6, 2009
(86) PCT No.: PCT/JP2009/050017

§ 371 Date: Jun. 29, 2010

(30) Foreign Application Priority Data
Feb. 22, 2008 (JP) 2008-042045

(51) Int. Cl. B25B 13/48; B25B 13/06

(52) U.S. Cl. 81/124.2; 81/124.5

(57) ABSTRACT

A socket 10 for a socket wrench according to the present embodiment is a socket for a socket wrench having a double structure made up of an outer cylinder 11 and an inner cylinder 12, and has slits 13A and 13B extending over the entire length along the axial direction of respective side surfaces of bodies 11a and 12a of the outer cylinder 11 and the inner cylinder 12, respectively. The outer cylinder 11 includes, at the leading end thereof, a leading-end fitting section 11c that corresponds to the shape of a head 16a of a fixing bolt of a member 16 to be fastened. The inner cylinder 12 includes a leading-end fitting section 12c that corresponds to the shape of a head 16b of a fastening bolt of the member 16 to be fastened. The leading-end fitting section 11c and the head 16a of the fixing bolt are fitted to fix the member 16 to be fastened, and the leading-end fitting section 12c and the head 16b of the fastening bolt are fitted to fasten the member 16 to be fastened, whereby a wire 17 is brought out from the inner cylinder 12 through the slits 13A and 13B.

### TECHNICAL FIELD

The present invention relates to a socket for a socket wrench that is a tool used for fastening or loosening bolts and nuts, and a method for fixing a member to be fastened.

### BACKGROUND ART

Fastening tools, such as box-end wrenches and socket wrenches, have been used as tools for fastening and loosening members to be fastened, such as bolts and nuts. A socket wrench includes an accommodating section formed into a regular hexagon, for example, that accommodates therein a nut or a bolt head that has a regular hexagonal outer shape, for example, and is used for fastening the nut or the bolt by applying torque in a state that the bolt head or the nut is accommodated in the accommodating section.

To extend a large number of wires or the like extending from a surface of a member through a member to be fastened, the wires or the like are preferably brought out as a bundle as much as possible. A method has been proposed to bundle the wires and bring the wires out as a bundle through a notch or the like provided to a part of a side surface of a fastening tool (Patent Document 1).

[Patent Document 1] Japanese Patent Application Laid-open No. S61-279471

### DISCLOSURE OF INVENTION

### Problem to be Solved by the Invention

However, the method to bundle the wires and bring the wires out as a bundle through a notch provided to a part of a side surface of a fastening tool arises a problem in that the notch is not fully useful for practical use, because the notch is provided only partially on the side surface of the fastening tool, therefore, the wires or the like cannot be brought in and out therethrough freely.

When tubes, wires, or the like are mounted, the tubes, the wires, or the like are mounted on a certain portion of the outer wall of a turbine, for example, in a concentrated manner in some cases. FIGS. 5 and 6 illustrate an example of mounting the tubes, the wires, or the like on a certain portion of the outer wall of a turbine in a concentrated manner with members to be fastened. As illustrated in FIGS. 5 and 6, when a large number of tubes 101, wires, or the like are made to pass through certain penetrating sections 103 of a turbine 102 in a concentrated manner and fixed to the penetrating sections 103 thus provided in a concentrated manner, as in conventional methods, members 104 and 105 to be fastened, such as a bolt and a nut, need to be attached to an outer wall surface 102a of the turbine 102, and fastened and loosened by using socket wrenches 106 and 107.

In such conventional methods for fastening and loosening the members 104 and 105 to be fastened with the socket wrenches 106 and 107 or the like, however, a problem arises in that other adjacent members 104 and 105 to be fastened become obstacles, making it impossible to perform fastening or loosening work of the members to be fastened.

Another problem arises in that a large number of wires or the like extending from the members 104 and 105 to be fastened become obstacles, making it impossible to perform fastening or loosening work of the members 104 and 105 to be fastened.

The present invention is made in consideration of the problems described above, and an object of the present invention is to provide a socket for a socket wrench that enables fixing of a member to be fastened even to a portion provided with a plurality of fixing sections in a concentrated manner.

### Means for Solving Problem

According to an aspect of the present invention, a socket for a socket wrench having a double structure made up of an outer cylinder and an inner cylinder interpolated in the outer cylinder includes slits extending over an entire length along an axial direction of respective side surfaces of bodies of the outer cylinder and the inner cylinder. The outer cylinder includes, at a leading end thereof, a leading-end fitting section that corresponds to a shape of a head of a fixing bolt of a member to be fastened that is attached to a surface of a member, and the inner cylinder includes a leading-end fitting section that corresponds to a shape of a head of a fastening bolt of the member to be fastened.

According to another aspect of the present invention, a method for fixing a member to be fastened with the socket for a socket wrench having a double structure includes: accommodating a wire or a pipe extending from the surface of the member in an accommodating section in the inner cylinder; mounting the outer cylinder and the inner cylinder to the member to be fastened; accommodating the head of the fixing bolt of the member to be fastened that is to be attached to the surface of the member in the leading-end fitting section of the outer cylinder; accommodating the head of the fastening bolt of the member to be fastened in the leading-end fitting section of the inner cylinder; turning the outer cylinder to fit the head of the fixing bolt to the leading-end fitting section of the outer cylinder and fixing the member to be fastened; turning the inner cylinder to fit the head of the fastening bolt to the leading-end fitting section of the inner cylinder and fastening the member to be fastened; and detaching the wire or the pipe through the slits provided on the respective side surfaces of the bodies of the outer cylinder and the inner cylinder.

### EFFECT OF THE INVENTION

According to the present invention, the socket for a socket wrench having the double structure made up of the outer cylinder and the inner cylinder has the slits extending over the entire length along the axial direction of the respective side surfaces of the bodies of the outer cylinder and the inner cylinder. The outer cylinder includes, at the leading end thereof, the leading-end fitting section that corresponds to the shape of the head of the fixing bolt of the member to be fastened that is attached to the surface of the member. The inner cylinder includes the leading-end fitting section that corresponds to the shape of the head of the fastening bolt of the member to be fastened. Therefore, at a portion provided with a plurality of fixing sections in a concentrated manner, the members to be fastened can be fixed to perform fastening and loosening of the members to be fastened without being affected by other adjacent members to be fastened, a large number of tubes, wires, or the like.

### BRIEF DESCRIPTION OF DRAWINGS

FIG. 1 is a simplified schematic of a structure of a socket for a socket wrench according to an embodiment of the present invention.

FIG. 2 is a simplified schematic of a structure of an outer cylinder of the socket for a socket wrench according to the embodiment of the present invention.

FIG. 3 is a simplified schematic of a structure of an inner cylinder of the socket for a socket wrench according to the embodiment of the present invention.

FIG. 4 is an exemplary view of the socket for a socket wrench according to the embodiment of the present invention that is applied to a member to be fastened for a penetrating section.

FIG. 5 is an exemplary view of a member to be fastened when being attached to an outer wall of a turbine.

FIG. 6 is a simplified view of a plurality of penetrating sections provided on the outer wall of the turbine.

### EXPLANATIONS OF LETTERS OR NUMERALS

10 socket for a socket wrench
11 outer cylinder
12 inner cylinder
11a, 12a body
11b, 12b accommodating section
11c, 12c leading-end fitting section
13A, 13B slit
14 member
14a surface
15 penetrating section
16 member to be fastened
16a head of a fixing bolt
16b head of a fastening bolt
17 wire
18, 20 spanner
19, 21 fastening upper end

### BEST MODE(S) FOR CARRYING OUT THE INVENTION

The present invention will now be explained in detail with reference to the accompanying drawings. This embodiment is not intended to limit the present invention. Elements described in the embodiment below include elements readily thought of by those skilled in the art and substantially equivalent elements.

### Embodiment

A Socket for a socket wrench according to an embodiment of the present invention will be explained with reference to some drawings.

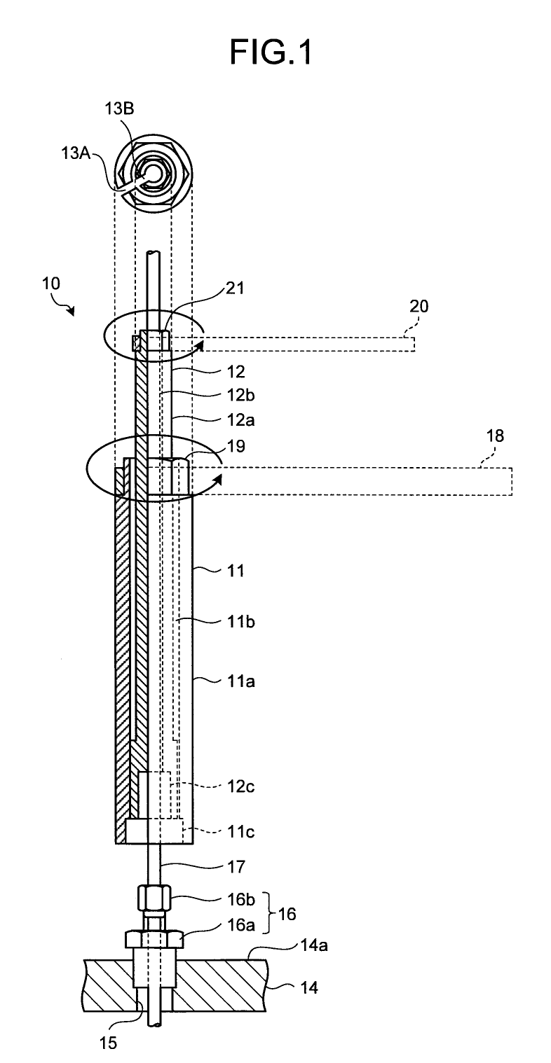

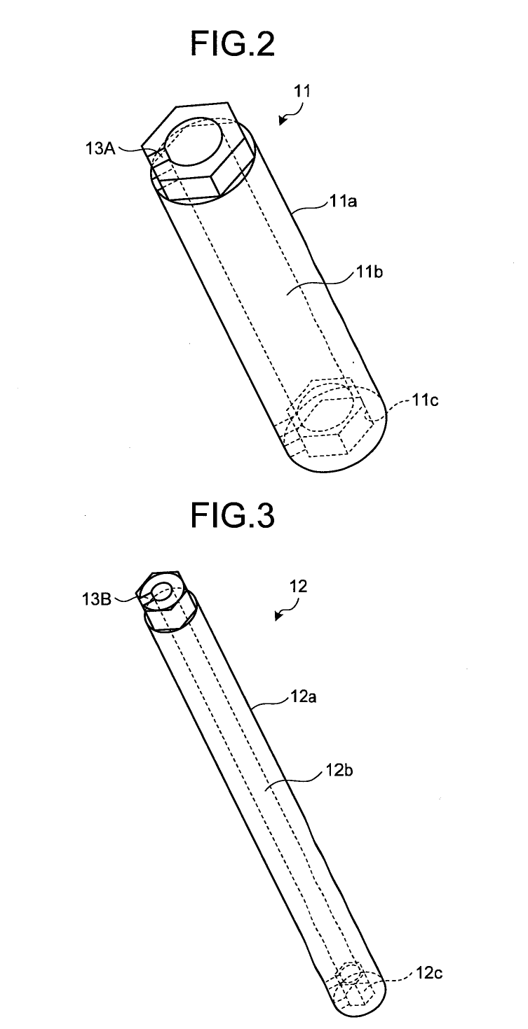

FIG. 1 is a simplified schematic of a structure of the socket for a socket wrench according to the present embodiment. FIG. 2 is a simplified schematic of a structure of an outer cylinder of the socket for a socket wrench according to the present embodiment. FIG. 3 is a simplified schematic of a structure of an inner cylinder of the socket for a socket wrench according to the present embodiment.

As illustrated in FIGS. 1 to 3, a socket 10 for a socket wrench according to the present embodiment is a socket for a socket wrench having a double structure made up of an outer cylinder 11 and an inner cylinder 12 interpolated in the outer cylinder 11, and has slits 13A and 13B extending over the entire length along the axial direction of respective side surfaces of bodies 11a and 12a of the outer cylinder 11 and the inner cylinder 12, respectively. The outer cylinder 11 includes, at the leading end thereof, a leading-end fitting section 11c that corresponds to the shape of a head 16a of a fixing bolt of a member 16 to be fastened. The inner cylinder 12 includes a leading-end fitting section 12c that corresponds to the shape of a head 16b of a fastening bolt of the member 16 to be fastened. The member 16 to be fastened is provided to a penetrating section 15 on a surface 14a of a member 14. In an accommodating section 12b of the inner cylinder 12, a wire 17 extending through the penetrating section 15 on the surface 14a of the member 14 is accommodated.

As with the socket 10 for a socket wrench according to the present embodiment, by providing the slits 13A and 13B extending over the entire length along the axial direction of the respective side surfaces of the bodies 11a and 12a of the outer cylinder 11 and the inner cylinder 12, respectively, the member 16 to be fastened is fixed to the penetrating section 15 and fastened, the slits 13A and 13B of the outer cylinder 11 and the inner cylinder 12, respectively, are aligned to each other thereafter, whereby the wire 17 in the accommodating section 12b of the inner cylinder 12 can be brought out easily.

In the socket 10 for a socket wrench according to the present embodiment, the outer cylinder 11 includes the leading-end fitting section 11c at the leading end of an accommodating section 11b of the outer cylinder 11. The leading-end fitting section 11c is configured to correspond to the shape of the head 16a of the fixing bolt of the member 16 to be fastened attached to the surface 14a of the member 14. Accordingly, the head 16a of the fixing bolt of the member 16 to be fastened that is to be attached to the surface 14a of the member 14 is accommodated in the leading-end fitting section 11c of the outer cylinder 11, a spanner 18 is attached to a fastening upper end 19 of the outer cylinder 11, and the outer cylinder 11 is turned to fit the head 16a of the fixing bolt to the leading-end fitting section 11c of the outer cylinder 11, whereby the position of the member 16 to be fastened can be fixed.

In the socket 10 for a socket wrench according to the present embodiment, the inner cylinder 12 includes the leading-end fitting section 12c at the leading end of the accommodating section 12b of the inner cylinder 12. The leading-end fitting section 12c is configured to correspond to the shape of the head 16b of the fastening bolt of the member 16 to be fastened. Accordingly, the head 16b of the fastening bolt of the member 16 to be fastened is accommodated in the leading-end fitting section 12c of the inner cylinder 12, a spanner 20 is attached to a fastening upper end 21 of the inner cylinder 12, and the inner cylinder 12 is turned to fit the head 16b of the fastening bolt to the leading-end fitting section 12c of the inner cylinder 12, whereby the member 16 to be fastened can be fastened.

The inner diameter of the accommodating section 11b of the outer cylinder 11 is set larger than the outer diameter of the accommodating section 12b of the inner cylinder 12, and the inner diameter of the leading-end fitting section 11c of the outer cylinder 11 is set larger than the outer diameter of the leading-end fitting section 12c of the inner cylinder 12. The inner cylinder 12 is thus prevented from turning in a manner to follow turns of the outer cylinder 11 caused to fix the member 16 to be fastened.

A fixing and fastening process of the member 16 to be fastened that is provided to the penetrating section 15 on the surface 14a of the member 14 will now be explained.

The member 16 to be fastened is attached to the penetrating section 15, and the wire 17 extending through the penetrating section 15 is made to pass through the member 16 to be fastened. The outer cylinder 11 and the inner cylinder 12 are mounted in this order on the member 16 to be fastened. The head 16a of the fixing bolt of the member 16 to be fastened is accommodated in the leading-end fitting section 11c of the outer cylinder 11, and the head 16b of the fastening bolt of the member 16 to be fastened is accommodated in the leading-end fitting section 12c of the inner cylinder 12. The wire 17 extending through the penetrating section 15 is made to pass inside the outer cylinder 11 and the inner cylinder 12, and accommodated in the accommodating section 12b of the inner cylinder 12.

The spanner 18 is attached to the fastening upper end 19 of the outer cylinder 11, and the outer cylinder 11 is turned to fit the head 16a of the fixing bolt to the leading-end fitting section 11c of the outer cylinder 11, whereby fixing of the position of the member 16 to be fastened is performed.

After the member 16 to be fastened is fixed, the spanner 20 is attached to the fastening upper end 21 of the inner cylinder 12, and the inner cylinder 12 is turned to fit the head 16b of the fastening bolt to the leading-end fitting section 12c of the inner cylinder 12, whereby fastening of the member 16 to be fastened is performed.

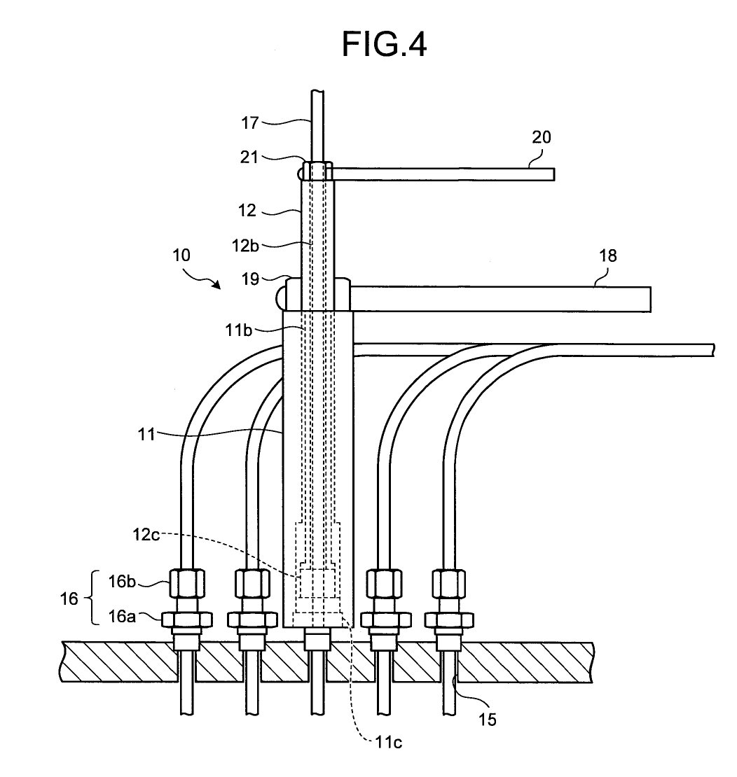

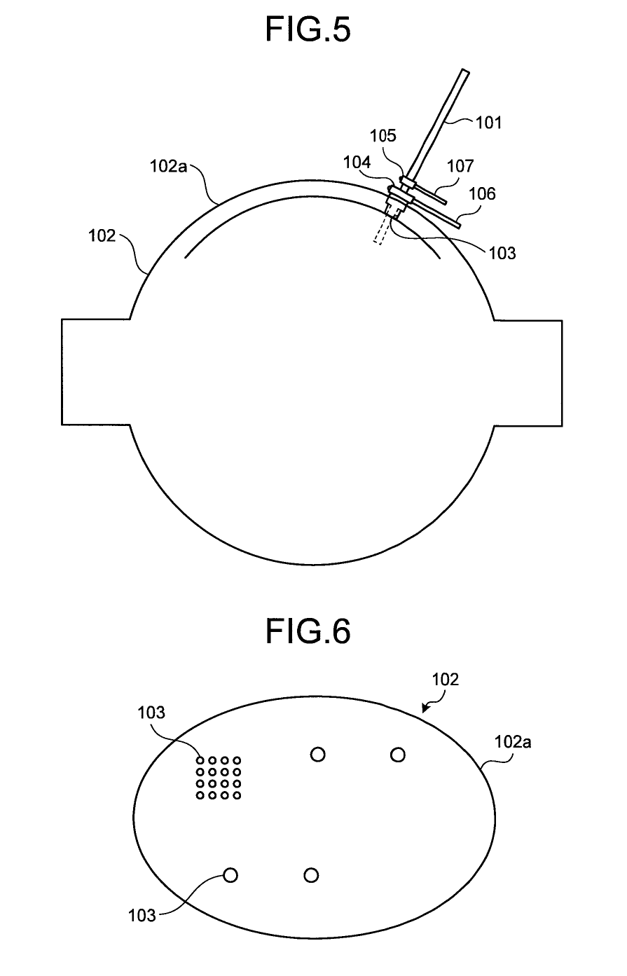

FIG. 4 is an exemplary view of the socket for a socket wrench according to the present embodiment that is applied to a member to be fastened for a penetrating section. As illustrated in FIG. 4, by mounting the socket 10 for a socket wrench on the member 16 to be fastened, the member 16 to be fastened on which the socket 10 for a socket wrench is mounted can be fixed and fastened without being affected by wires extending through other penetrating sections 15.

The outer cylinder 11 and the inner cylinder 12 are lifted thereafter to be detached from the member 16 to be fastened. The slits 13A and 13B of the outer cylinder 11 and the inner cylinder 12, respectively, are aligned to each other, and the wire 17 that is made to pass through the accommodating section 12b of the inner cylinder 12 is brought out through the slits 13A and 13B. The wire 17 can be thus easily detached from the outer cylinder 11 and the inner cylinder 12 through the slits 13A and 13B, respectively; therefore, the wire 17 can be attached to and detached from the outer cylinder 11 and the inner cylinder 12.

The outer cylinder 11 and the inner cylinder 12 thus detached are mounted on another member 16 to be fastened that is attached to another penetrating section 15, and the same operation as that described above is performed.

By using the socket 10 for a socket wrench according to the present embodiment, the member 16 to be fastened can be fixed to perform fastening and loosening of the member 16 to be fastened without being affected by other adjacent members 16 to be fastened, wires 17 or the like extending through other penetrating sections 15.

The outer cylinder 11 and the inner cylinder 12 can be made of, for example: aluminum or other light-weight materials; a steel tube, a stainless tube, an iron tube, a resin tube, steel, or other high-strength materials; or an appropriate combination of such materials that are integrally combined.

In the socket 10 for a socket wrench according to the present embodiment, the inner diameter of the leading-end fitting section 11c of the outer cylinder 11 is set larger than the outer diameter of the leading-end fitting section 12c of the inner cylinder 12; however, the present invention is not limited to this. The inner diameter of the leading-end fitting section 11c of the outer cylinder 11 may be set to be the same size as the outer diameter of the leading-end fitting section 12c of the inner cylinder 12. In this manner, the outer cylinder 11 and the inner cylinder 12 are mounted on the member 16 to be fastened, and the member 16 to be fastened can be fixed to perform fastening and loosening of the member 16 to be fixed.

In the socket 10 for a socket wrench according to the present embodiment, the inner diameter of the accommodating section 12b of the inner cylinder 12 is preferably larger than the width of the slit 13B. This is for preventing the wire 17 or the like accommodated in the accommodating section 12b of the inner cylinder 12 from slipping from the slit 13B during, for example, fixing or fastening work of the member 16 to be fastened. The inner diameter of the accommodating section 12b of the inner cylinder 12 may be set to be the same as the width of the slit 13B.

In this manner, by using the socket for a socket wrench according to the present embodiment, because the socket for a socket wrench has slits 13A and 13B on the respective side surfaces of the bodies 11a and 12a of the outer cylinder 11 and the inner cylinder 12, respectively, the member 16 to be fastened that is attached to the penetrating section 15 can be fixed to perform fastening and loosening of the member 16 to be fastened without being affected by the wires 17 or the like extending through the other penetrating sections 15. Moreover, because the wires 17 can be easily detached through the slits 13A and 13B, the wires 17 can be attached to and detached from the outer cylinder 11 and the inner cylinder 12.

The socket for a socket wrench employed in the present embodiment is employed for an outer wall surface of a turbine in a gas turbine facility. However, the present invention is not limited to this, and is applicable for other facilities as long as they have penetrating sections.

### INDUSTRIAL APPLICABILITY

As described above, the socket for a socket wrench according to the present invention has the slits on the respective side surfaces of the outer cylinder and the inner cylinder, and enables fixing, fastening, and loosening of the member to be fastened without being affected by wires or the like extending through other penetrating sections. Therefore, the socket for a socket wrench is suitable for a socket for a socket wrench that fixes a plurality of members to be fastened that is mounted on a certain portion in a concentrated manner.

1. A socket for a socket wrench having a double structure made up of an outer cylinder and an inner cylinder interpolated in the outer cylinder, the socket comprising:
slits extending over an entire length along an axial direction of respective side surfaces of bodies of the outer cylinder and the inner cylinder, wherein
the outer cylinder includes, at a leading end thereof, a leading-end fitting section that corresponds to a shape of a head of a fixing bolt of a member to be fastened that is attached to a surface of a member, and
the inner cylinder includes a leading-end fitting section that corresponds to a shape of a head of a fastening bolt of the member to be fastened.

2. A method for fixing a member to be fastened with the socket for a socket wrench having a double structure according to claim 1, the method comprising:
accommodating a wire or a pipe extending from the surface of the member in an accommodating section in the inner cylinder;
mounting the outer cylinder and the inner cylinder to the member to be fastened;
accommodating the head of the fixing bolt of the member to be fastened that is to be attached to the surface of the member in the leading-end fitting section of the outer cylinder;
accommodating the head of the fastening bolt of the member to be fastened in the leading-end fitting section of the inner cylinder;
turning the outer cylinder to fit the head of the fixing bolt to the leading-end fitting section of the outer cylinder and fixing the member to be fastened;
turning the inner cylinder to fit the head of the fastening bolt to the leading-end fitting section of the inner cylinder and fastening the member to be fastened; and
detaching the wire or the pipe through the slits provided on the respective side surfaces of the bodies of the outer cylinder and the inner cylinder.
